(19) United States
(12) Patent Application Publication
(10) Pub. No.: US 2025/0163226 A1
(43) Pub. Date: May 22, 2025

(54) Analytical Method for Preparing PEKK for SLS Process

(71) Applicant: Hexcel Corporation, San Ramon, CA (US)

(72) Inventors: David Grulke, Tolland, CT (US); Emily Thomsen, Barkhamstead, CT (US)

(73) Assignee: Hexcel Corporation, San Ramon, CA (US)

(21) Appl. No.: 18/512,268

(22) Filed: Nov. 17, 2023

(51) Int. Cl. C08J 3/00; B29C 64/153; B29K 71/00

(52) U.S. Cl. CPC C08J 3/00; B29C 64/153; B29K 2071/02; C08J 2371/02

(57) ABSTRACT

A method of preparing a polymer powder composition suitable for selective laser sintering and a powder composition obtained from the same. The polymer composition comprising at least two polyetherketoneketone polymorphs, each of the polymorphs having a different melting peak in a melting temperature range. The polymer is heated at a temperature below the lowest of the polymorphs melting peaks thereby decreasing the melting temperature range of the polymer composition. The treatment is especially useful with Cake B PEKK powder, which is otherwise unusable in SLS. Parts built from the treated powder using SLS have reduced surface anomalies and are easier to remove from the Cake bed.

### TECHNICAL FIELD

The present disclosure generally relates to additive manufacturing technology and techniques, and more specifically relates to a polyether ketone ketone (“PEKK”) powder composition for use in selective laser sintering (“SLS” or “LS”), a method for preparing the powder composition, and a method for additively manufacturing an object using the PEKK powder composition.

### BACKGROUND

It is known to use additive manufacturing technology and techniques, together with polymer powders, to manufacture high-performance products having applications in various industries (e.g., aerospace, industrial, medical, etc.).

Selective Laser Sintering (“SLS”) is an additive manufacturing technique that uses a laser to fuse small particles of polymer into a mass having a desired three-dimensional (3-D) shape. The laser selectively fuses the powder material by scanning cross-sectional layers generated from a 3-D digital description of the desired object onto the top layer of a bed of the powder material. After a cross-sectional layer is scanned, the powder bed is lowered by one-layer thickness in a z-axis direction, a new top layer of powder material is applied to the powder bed, and the powder bed is rescanned. This process is repeated until the object is completed. When completed, the object is formed in a “cake” of unfused powder material. The formed object is extracted from the cake. The powder material from the cake can be recovered, sieved, and used in a subsequent SLS process.

Polyaryletherketones (“PAEK”) are of interest in the SLS process because parts that have been manufactured from PAEK powder or PAEK granulates are characterized by a low flammability, a good biocompatibility, and a high resistance against hydrolysis and radiation. The thermal resistance at elevated temperatures as well as the chemical resistance distinguishes PAEK powders from ordinary plastic powders. A PAEK powder may be a powder from the group consisting of polyetheretherketone (“PEEK”), polyetherketoneketone (“PEKK”), polyetherketone (“PEK”), polyetheretherketoneketone (“PEEKK”) or polyetherketoneetherketoneketone (“PEKEKK”).

PEKK powders are of particular interest in the SLS process because objects that have been manufactured from PEKK powders via SLS have demonstrated not only the above characteristics but also superior strength relative to other PAEK materials.

PEKK powders are unique in the SLS technique because unfused PEKK powder can be recycled in subsequent SLS processes. After an SLS build, the mass yield from the built part relative to the unsintered powder is typically less than 20% of the powder material used in the SLS process.

After the build, parts are removed from the cake bed, the remaining PEKK material is referred to as used PEKK material or recycled PEKK material. This material is referred to as used or recycled because it has been used at least once in the SLS process. In other words, this material has been raised to the bed temperature and added to the bed in a layer-wise fashion. Material adjacent to the used material was sintered in the initial SLS process.

After the parts are removed from the cake, the PEKK powder forming the cake is recycled for subsequent use in the SLS process. Sieving of the cake is performed to restore common size to the recovered cake structure, which is typically lumpy. The sieve size may be similar to the original powder or the sieve size may be different than the original powder. In the process described, it is preferred that the sieve size falls in the 20-200 micron range. It is possible to blend batches of used sieved PEKK powder. However, it is preferred that batches of used sieved PEKK powder that are blended have similar thermodynamic properties. The use of DSC, FTIR, and other analytical methods may be used to determine which batches of used sieved PEKK powder can be mixed. A test build can be used to validate analytical results.

The Applicant is the owner of U.S. Patent Publication No. US 20130217838 for a Method for Processing PAEK and Articles Manufactured from the Same the contents of which are incorporated herein by reference. As set forth in that disclosure, the SLS powder may be subject to multiple iterations of recycle. The term virgin powder in the context of SLS recycling refers to a SLS powder that has not been subjected to ambient chamber conditions during a SLS build. The term first recycle or Cake A refers to a polymer composition that has previously been subjected to a heating load in a first selective laser sintering build process having a bed temperature between the lowest of the polymorph melting peaks and the highest of the polymorph melting peaks determined prior to the first selective laser sintering building process. The term second recycle or Cake B refers to a polymer composition that has previously been subjected to a heating load in a second selective laser sintering build process having a bed temperature between the lowest of the polymorph melting peaks and the highest of the polymorph melting peaks as determined after the first selective laser sintering building process and prior to the second selective laser sintering building process.

A disadvantage of performing SLS on PEKK powders is that parts made from the PEKK powder do not have good strength characteristics as compared to parts made by other techniques, such as extruding. This is especially true in the out-of-plane axis or z-axis.

Another disadvantage of PEKK powder and recycled PEKK powder for use in selective laser sintering is that it is difficult to remove the unfused powder that is unsintered after an SLS build. This is powder that was subject to the bed temperature during the SLS build, but that was not sintered via the laser. Thus, this powder surrounds the formed parts. The formed parts are removed from the cake bed. A further disadvantage with known PEKK powders is that this process can be difficult because unfused powder can tend to remain hard and it difficult to remove, especially proximate to the sintered parts. It may require use of bead blasting to remove the powder from the build parts. This creates the potential for part loss and injury.

Another disadvantage of PEKK recycling methods is that it is not possible to reliably build parts from Cake B powder. As a result, Cake B powder cannot be used in commercial manufacture and significant amounts of unsintered powder is wasted in the SLS process, resulting in increased expense.

Another disadvantage of known methods and powder compositions is that attempted SLS of Cake B powder PEKK causes unwanted variations in the thickness of the built part, particularly in out-of-plane surfaces resulting in nonconforming parts that are not acceptable to customers.

Another disadvantage of SLS with Cake B PEKK is that the built parts result in a phenomenon referred to as “tiger striping.” This is when the problem with unwanted variation in part thickness manifests itself in stripes on the outside surface of a part made from the SLS. In reference to FIG. 1B, a test specimen made via SLS of PEKK exhibits the tiger striping. This is not acceptable to customers because of the deviations in part dimensions and due to the negative aesthetic effect.

A disadvantage of performing SLS on powder compositions with Cake B PEKK is that it is difficult to build objects when Cake B PEKK is included in the feedstock because it inhibits the application of powder in the SLS machine. For example, the Cake B may cause pilling, sticking, and other forms of fouling in steps of the SLS process in which smooth flowing powder are required. Therefore, it is understood that it is not commercially viable to operate the SLS machine to build parts using Cake B PEKK.

Thus, there exists a need in the art for an improved selective laser sintering method and improved powder for use therein.

### SUMMARY OF THE INVENTION

The needs set forth herein as well as further and other needs and advantages are addressed by the present teachings, which illustrate solutions and advantages described below.

It is an objective of the present teachings to remedy the above drawbacks and issues associated with prior art selective laser sintering methods and powder compositions.

The present invention resides in one aspect in a method of preparing a polymer powder composition suitable for selective laser sintering. The method includes the step of providing a polymer composition comprising at least two polyetherketoneketone polymorphs. Each of the polymorphs has a different melting peak. The polymer composition has a melting temperature range between a lower temperature and an upper temperature. Each of the melting peaks of the polymorphs falls within the melting temperature range. The method further includes the step of determining a temperature to heat treat the polymer composition, the temperature being between 250 degrees Celsius and the lowest of the polymorph melting peaks. The method further includes the step of subjecting the polymer composition comprising the at least two semicrystalline polymorphs to said determined temperature being between 250 degrees Celsius and the lowest of the polymorph melting peaks for a period of time that decreases the melting temperature range of the polymer composition.

In yet a further embodiment of the present invention the temperature to heat treat the polymer composition is between the lower temperature of the melting temperature range of the polymer composition before the step of subjecting the polymer composition to the temperature for the period of time and the lowest of the polymorph melting peaks.

In yet a further embodiment of the present invention, the temperature to heat treat the polymer composition is between 20 degrees Celsius below the lowest of the polymorph melting peaks and the lowest of the polymorph melting peaks.

In yet a further embodiment of the present invention, the temperature to heat treat the polymer composition is between 10 degrees Celsius below the lowest of the polymorph melting peaks and the lowest of the polymorph melting peaks.

In yet a further embodiment of the present invention, the melting temperature range of the polymer composition is decreased by at least 20%.

In yet a further embodiment of the present invention, the melting temperature range of the polymer composition is decreased so that it is 100 degrees Celsius or less.

In yet a further embodiment of the present invention, the melting temperature range of the polymer composition is decreased so that it is 60 degrees Celsius or less.

In yet a further embodiment of the present invention, the polymer composition has previously been subjected to a heating load in a first selective laser sintering build process having a bed temperature between the lowest of the polymorph melting peaks and the highest of the polymorph melting peaks determined prior to the first selective laser sintering building process.

In yet a further embodiment of the present invention, the polymer composition has previously been subjected to a heating load in a second selective laser sintering build process having a bed temperature between the lowest of the polymorph melting peaks and the highest of the polymorph melting peaks as determined after the first selective laser sintering building process and prior to the second selective laser sintering building process.

In yet a further embodiment of the present invention, the polyetherketoneketone comprises repeating units represented by Formulas I and II:

-A-C(═O)—B—C(═O)— I (Isomer T)

-A-C(═O)-D-C(═O)— II (Isomer I)
where A is a p,p′-Ph-O-Ph- group, Ph is a phenylene radical, B is p-phenylene, and D is m-phenylene, wherein the T:I isomer ratio is in the range of from 50/50 to 90/10, thereby forming said heat-treated polymer composition.

In yet a further embodiment of the present invention, the T:I ratio is 60:40.

In yet a further embodiment of the present invention, the step of determining the temperature to heat treat the polymer composition comprises the step of deconvoluting an endothermic melting peak of the polymer composition to determine the melting temperature range of the polymer composition and to determine the melting peak of each of the polymorphs.

The invention resides in another aspect in a polymer powder composition suitable for selective laser sintering. The polymer powder composition includes at least two polyetherketoneketone polymorphs, each of the polymorphs having a different melting peak, the polymer composition having a melting temperature range between a lower temperature and an upper temperature. Each of the melting peaks of the polymorphs falls within the melting temperature range. The polymer powder composition is made by a process comprising the following steps. The first step includes determining a temperature to heat treat the polymer composition. The temperature is between 250 degrees Celsius and the lowest of the polymorph melting peaks. Next, the process includes the step of subjecting the polymer composition comprising at least two semicrystalline polymorphs to said determined temperature being between 250 degrees Celsius and the lowest of the polymorph melting peaks for a period of time that decreases the melting temperature range of the polymer composition.

In yet a further embodiment of the present invention, the polymer composition is processed via the above described steps.

These and other aspects of the present invention will become apparent in light of the drawings and detailed description provided below.

### BRIEF DESCRIPTION OF THE DRAWINGS

FIG. 1A illustrates a SLS machine in accordance with one embodiment of the present invention.

FIG. 1B is an image of a portion of a part built from PEKK and carbon fiber using SLS.

FIG. 2A is a chart of melt curves for polymer powders at different recycle levels.

FIG. 2B is a chart of a melt curve for a polymer powder.

FIG. 2C is chart of the deconvoluted melting peak of the melt curve shown in FIG. 2B using curve fitting functions.

FIG. 3A is a chart of the deconvoluted melting peak of a melt curve of a selective laser sintering powder comprising virgin PEKK.

FIG. 3B is a chart of the deconvoluted melting peak of a melt curve of a selective laser sintering powder comprising Cake A PEKK.

FIG. 3C is a chart of the deconvoluted melting peak of a melt curve of a selective laser sintering powder comprising Cake B PEKK.

FIG. 4A is a chart of the deconvoluted melting peak of a melt curve of a selective laser sintering powder comprising Cake B PEKK.

FIG. 4B is a chart of the deconvoluted melting peak of a melt curve of the selective laser sintering powder comprising Cake B PEKK illustrated in FIG. 4A after the powder was subject to the heat treatment process in accordance with the present invention.

### DETAILED DESCRIPTION

The present disclosure describes aspects of the present invention with reference to the exemplary embodiments illustrated in the drawings; however, aspects of the present invention are not limited to the exemplary embodiments illustrated in the drawings. It will be apparent to those of ordinary skill in the art that aspects of the present invention include many more embodiments. Accordingly, aspects of the present invention are not to be restricted in light of the exemplary embodiments illustrated in the drawings. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

Polymorphic materials, having more than one crystalline form, are known in the art. The different crystalline forms may be referred to as polymorphs. Several studies have identified these crystalline structures in alternating polyketones and poly(aryl ether ketone ketone) such as Cheng, Z. D. et al, “Polymorphism and crystal structure identification in poly(aryl ether ketone ketone)s”, Macromol. Chem Phys. 197, 185-213 (1996); and Klop. E. A., et. al., “Polymorphism in Alternating Polyketones Studied by X-ray Diffraction and Calorimetry”, Journal of Polymer Science: Part B: Polymer Physics, Vol. 33, 315-326 (1995).

The present invention is especially useful for preparing polyetherketoneketone (PEKK) powder compositions for use in selective laser sintering. It is understood in the art that Cake B PEKK powder cannot be used in the SLS process due to the aforementioned disadvantages. The associated problems with printing Cake B with SLS only manifest themselves further when carbon fiber is included in the powder composition with the powder.

The inventors have discovered a solution that addresses the disadvantages associated with printing recycled PEKK powder compositions. Namely, the inventors have discovered that lower crystalline forms or polymorphs are transformed by thermal aging during the SLS process, wherein the bed temperature is maintained between the lowest of the polymorph melting peaks and the highest of the polymorph melting peaks for the entirety of the build process, which may range between 24 and 96 hours. The inventors have discovered that thermal aging results in a significant increase in the melting temperature range of the polymer powder composition. In some cases, this is greater than 100%. The inventors have discovered that the increased melting temperature range has caused problems during the SLS process associated with the recycled PEKK powder.

The inventors have discovered a solution to address the increased melting temperature range caused by the thermal aging of powders during the SLS process. First, the inventors have discovered the step of deconvoluting an endothermic melting peak of the polymer composition to determine the melting temperature range of the polymer composition and to determine the melting peak of each of the polymorphs. The inventors have discovered that deconvolution of the melting enthalpy enables the visualization of the discrete crystalline forms and the melting temperature range of the polymer. The inventors have further discovered that heat treating the polymer at a temperature selected between the lower temperature of the melting temperature range of the polymer composition before the step of heat treating the polymer composition and the lowest of the polymorph melting peaks for a period of time sufficient to decrease the melting temperature range of the polymer composition results in a polymer powder that can be used in the SLS process and that avoids the problems associated with SLS of recycle PEKK. Namely, the inventors have discovered that reducing the melting temperature range is essential to obtaining a recycled powder that can be used in the SLS process. This discovery may be particularly relevant to recycled PEKK powders, including cake B.

PAEKs are of interest in the SLS process because parts that have been manufactured from PAEK powder or PAEK granulates are characterized by a low flammability, a good biocompatibility, and a high resistance against hydrolysis and radiation. The thermal resistance at elevated temperatures as well as the chemical resistance distinguishes PAEK powders from ordinary plastic powders. A PAEK polymer powder may be a powder from the group consisting of polyetheretherketone (“PEEK”), polyetherketoneketone (“PEKK”), polyetherketone (“PEK”), polyetheretherketoneketone (“PEEKK”) or polyetherketoneetherketoneketone (“PEKEKK”).

PEKKs are well-known in the art and can be prepared using any suitable polymerization technique, including the methods described in the following patents, each of which is incorporated herein by reference in its entirety for all purposes: U.S. Pat. Nos. 3,065,205; 3,441,538; 3,442,857; 3,516,966; 4,704,448; 4,816,556; and 6,177,518. PEKK polymers differ from the general class of PAEK polymers in that they often include, as repeating units, two different isomeric forms of ketone-ketone. These repeating units can be represented by the following Formulas I and II:

-A-C(═O)—B—C(═O)— I

-A-C(═O)-D-C(═O)— II
where A is a p,p′-Ph-O-Ph-group, Ph is a phenylene radical, B is p-phenylene, and D is m-phenylene. The Formula I:Formula II isomer ratio, commonly referred to as the T:I ratio, in the PEKK is selected so as to vary the total crystallinity of the polymer. The T:I ratio is commonly varied from 50:50 to 90:10, and in some embodiments 60:40 to 80:20. A higher T:I ratio such as, 80:20, provides a higher degree of crystallinity as compared to a lower T:I ratio, such as 60:40.

In PEKK(T), two crystalline forms, forms I and II, are observed. Form I can be produced when samples are crystallized from melting at low supercooling, while Form II is typically found via solvent-induced crystallization or by cold-crystallization from the glassy state at relatively high supercooling. PEKK(I) possesses only one crystal unit cell which belongs to the same category as the Form I structure in PEKK(T). The c-axis dimension of the unit cell has been determined as three phenylenes having a zig-zag conformation, with the meta-phenylene lying on the backbone plane. PEKK(T/I) shows crystalline forms I and II (as in the case of PEKK(T)) and also shows, under certain conditions, a form III.

Suitable PEKKs are available from several commercial sources under various brand names. For example, polyetherketoneketones are sold under the brand name OXPEKK® polymers by Oxford Performance Materials, South Windsor, Connecticut. Polyetherketoneketone polymers are also manufactured and supplied by Arkema. In addition to using polymers with a specific T:I ratio, mixtures of polyetherketoneketones may be employed.

A purification step is optionally performed prior to grinding the raw PEKK. The purification process is the subject of U.S. Pat. No. 10,926,432B2 filed on Jan. 16, 2018 by Hexcel Corporation and titled “Polymer Powder and Method of Using the Same.” The disclosure of that reference is hereby incorporated by reference. The raw PEKK is heated for a sufficient time such that after the step of heating, the raw PEKK has a purity greater than 99.75% as determined by the ASTM E1868 loss-on-drying test method. During the heating step for purification, the PEKK is maintained at a temperature not exceeding 250 degrees Celsius between one and four hours to reduce purities in the PEKK powder. Furthermore, the purification step is not performed on PEKK powder. In addition, the purification step is only performed once before use of the PEKK in SLS and it is not performed on substantive iterations of the powder as the powder has already been purified.

A grinding or milling step is performed that involves grinding the raw PEKK flake to form what will hereinafter be referred to as the “PEKK powder.” The grinding step can be performed using known grinding techniques performed by companies such as Aveka, Inc. of Woodbury, MN. Upon completion of the grinding step, the particles of the PEKK powder are significantly smaller (i.e., several degrees of magnitude smaller) than the particles of the raw PEKK. The particles of the PEKK powder are more consistent and regular in shape as compared to the particles of the raw PEKK; however, the particles of the PEKK powder are still irregularly-shaped in comparison to spherical-shaped particles.

U.S. Pat. No. 10,870,130B2 to Hexcel Inc. for a Method for Preparing Fine Powders for Use in Selective Laser Sintering Processes discloses information on the preparation of PEKK powder for use in the SLS. That publication is hereby incorporated by reference. U.S. Pat. No. 10,619,032B2 to Hexcel for a Polymer Powder and Method of Preparing the Same discloses additional information regarding powder preparation. That publication is hereby incorporated by reference. The raw PEKK flake is ground into a PEKK powder comprising a plurality of PEKK particles. The PEKK particles range in size from less than 10 μm to about 200 μm. A person of ordinary skill in the art and familiar with this disclosure will understand that the particle size range will vary based on the type of polymer being milled and the specific parameters of the milling process.

After the grinding step, another optional processing step is performed that involves adding an amount of carbon fiber to the PEKK powder. The mixing process is the subject of U.S. Pat. No. 10,661,479B2 published on May 26, 2020 by Hexcel Corporation and titled “Polymer Powder and Method of Preparing the Same.” The disclosure of that reference is hereby incorporated by reference.

In accordance with one embodiment of the present invention carbon fiber available from Hexcel Corporation of Stamford, Connecticut, USA and sold under the brand name HEXTOW® AS4 is employed. The carbon fiber is a continuous, high strength, high strain, PAN based fiber. In this embodiment, the carbon fiber has a filament diameter of approximately 7.1 μm and is wound on a cardboard tube. It should be understood to a person having ordinary skill in the art that different types and brands of carbon fibers may be employed, and that the present invention is not specifically limited in this regard. The carbon fiber is milled prior to incorporation into the PEKK powder to achieve the desired carbon fiber length as determined by the average L50. The carbon fiber is milled by a miller such as E&L Enterprises Inc. in Oakdale, TN, USA. For example, in one embodiment of the present invention, the mean carbon length, L50, is 77 μm. The minimum length measured is 38.15 am, the maximum length measured is 453 μm, and the standard deviation is 42.09 μm.

A powder composition suitable for use in selective laser sintering for printing a three-dimensional object is prepared by combining a PEKK powder with the carbon fiber. In some embodiments of the present invention the composition includes 85% by weight of PEKK powder and 15% by weight carbon fiber. In yet other embodiments of the present invention, the amount of carbon fiber is varied relative to the polymer powder to achieve composition for SLS. In some embodiments, the powder may exclude carbon fiber. This may be referred to as neat powder. In some embodiments of the present invention, one or more additives, fillers, or reinforcements maybe added to the matrix to affect the properties of the SLS composition, for example, during the printing process or in the printed article. It will be understood to a person of ordinary skill in the art and familiar with this invention, that the ratio of carbon to polymer may vary and the above examples are provided for illustration purposes.

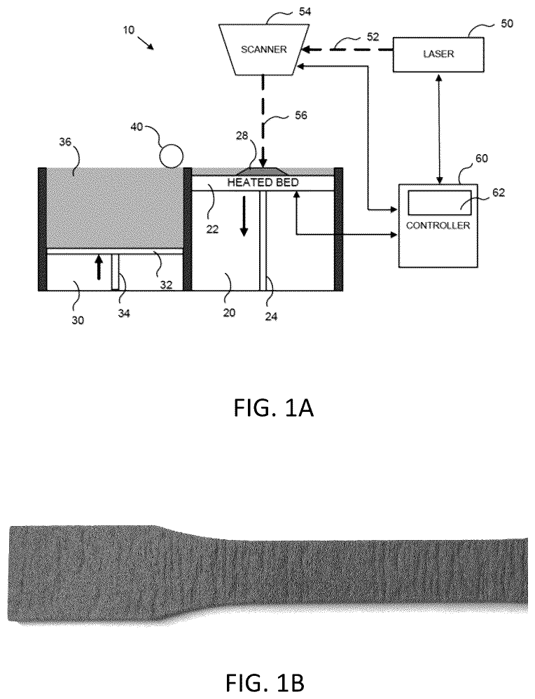

According to one embodiment of the present invention, in reference to FIG. 1, a SLS system 10 in accordance with the present invention is illustrated. The system 10 includes a first chamber 20 having an actuatable piston 24 deposed therein. A bed 22 is deposed at an end of the piston 24. It should be understood that the term bed may refer to the physical structure supported on the piston or the uppermost layer of powder deposed thereon.

The temperature of the bed 22 can be variably controlled via a controller 60 in communication with heating elements (not shown) in or around the bed 22. Furthermore, the SLS system 10 according to the invention may include a heating device (not shown) above the bed 22, which preheats a newly applied powder layer up to a working temperature below a temperature at which the solidification of the powder material occurs. The heating device may be a radiative heating device (e.g., one or more radiant heaters) which can introduce heat energy into the newly applied powder layer in a large area by emitting electromagnetic radiation.

A second chamber 30 is adjacent to the first chamber 20. The second chamber 30 includes a table surface 32 disposed on an end of a piston 34 deposed therein. A powder 36 for use in the SLS system 10 is stored in the second chamber 30 prior to the sintering step. It will be understood to a person of ordinary skill in the art and familiar with this disclosure that while a specific embodiment of a SLS system is disclosed, the present invention is not limited thereto, and different known SLS systems may be employed in the practice of the present invention.

During operation of the SLS system 10, a spreader 40 translates across a top surface of the first chamber 20, evenly distributing a layer of powder 36 across onto either the top surface of the bed 22 or the material previously deposed on the bed 22. The SLS system 10 preheats the powder material 36 deposed on the bed 22 to a temperature proximate to a melting peak of the powder. Typically, a layer of powder is spread to have a thickness of 125 μm, however the thickness of the layer of powder can be increased or decreased depending on the specific SLS process and within the limits of the SLS system.

A laser 50 and a scanning device 54 are deposed above the bed 22. The laser 50 transmits a beam 52 to the scanner 54, which then distributes a laser beam 56 across the layer of powder 36 deposed on the bed 22 in accordance with build data. The laser selectively fuses powder material by scanning cross-sections generated from a three-dimensional digital description of the part on the surface of the bed having a layer of the powder material deposed thereon. The laser 50 and the scanner 54 are in communication with the controller 60. After a cross-section is scanned, the bed 22 is lowered by one layer thickness (illustrated by the downward arrow), a new layer of powdered material is deposed on the bed 22 via the spreader 40, and the bed 22 is rescanned by the laser. This process is repeated until a build 28 is completed. During this process, the piston 34 in the second chamber is incrementally raised (illustrated by the upward arrow) to ensure that there is a sufficient supply of powder 36.

The inventors have identified a disadvantage of SLS of PEKK powder and SLS of PEKK powder with carbon fiber additive is that it is not possible to print parts from Cake B PEKK that are commercially viable. In some instances, it may be technically possible to operate the SLS machine to print solid parts from Cake B PEKK, however exhibits different problems that make them commercially unviable. As a result, Cake B powder is typically considered a write off. The first problem is that Cake B performs very poorly during the powder coating process in the SLS machine relative to virgin powder and Cake A. The Cake B PEKK powder tends to clump together and foul the coating process such that it causes many SLS builds, which can last between several hours and several days depending on the depth of the build, to fail. As a result of this failure it is understood that Cake B PEKK cannot be used to print parts on a commercial scale.

In some circumstances it is possible to avoid the powder application issues with Cake B PEKK and print parts using the SLS process. In these circumstances, the SLS process remains commercially unfeasible because the removal of the sintered parts from the powder bed is substantially more time consuming and difficult as compared to parts printed from virgin powder or Cake A powder because the unsintered Cake B powder is difficult to remove from the areas proximate to the built parts. The unsintered powder tends to clump to the built part and inhibit removal of the part from the powder bed rendering use of Cake B PEKK unfeasible.

Another disadvantage of printing SLS Cake B PEKK, to the extent it is possible, is that it results in parts with significant deviations in part thickness relative to the built part in the design file inputted into the SLS machine. The thickness deviations are visible in out-of-plane surfaces in the form of striping on the surface of parts. In some embodiments, this is referred to as striping or tiger striping. In reference to FIG. 1B, an image showing a portion of a part built from Cake B PEKK with 15% carbon fiber using SLS is shown. In this image, the striping is readily visible on the surface of the built part. The tiger striping renders the built parts commercially unviable.

The striping in the surface of the part precludes use of PEKK B for several reasons. First, the striping negatively affects the aesthetics of the constructed part, thereby reducing the desirability of the SLS printed part by customers. Second, the deviations in thickness are to such an extent that the parts are consistently rejected by customers, particularly in aerospace and other areas that require high precision manufacturing. For example, a customer may accept parts that are within −0.010″/+0.020″ of the specified drawing dimension. Companies such as the Applicant can routinely print SLS parts using virgin PEKK and Cake A PEKK that meet this requirement. However, it is not possible to reliably print SLS parts from Cake B that meet this requirement.

The inventors have discovered a solution that addresses the disadvantages associated with printing recycled PEKK powder compositions. The solutions addresses the aforementioned problems associated with printing PEKK B, but also may be applicable to other powder levels to improve the performance thereof. Namely, the inventors have discovered that lower crystalline forms or polymorphs are transformed by thermal aging during the SLS process, wherein the bed temperature is maintained between the lowest of the polymorph melting peaks and the highest of the polymorph melting peaks for the entirety of the build process, which may range between 24 and 96 hours. This transformation manifests itself as a thermal aging of the powders. The inventors have discovered that thermal aging results in a significant increase or widening of the melting temperature range of the polymer powder composition. In some cases, this widening is greater than 100%. The inventors have discovered that the increased melting temperature range contributes to the problems associated with the subsequent printing of such aged powders, also referred to as recycled PEKK powder.

The inventors have discovered a solution to address the problem with the increased or widened melting temperature range caused by the thermal aging of powders during the SLS process. First, the inventors have discovered the step of deconvoluting an endothermic melting peak of the polymer composition to determine the melting temperature range of the polymer composition and to determine the melting peak of each of the polymorphs. The term “melting peak” as used herein refers to the melting peak of a particular polymorph. The inventors have discovered that deconvolution of the melting enthalpy enables the visualization of the discrete crystalline forms and the melting temperature range of the polymer. The inventors have further discovered that heat treating the polymer at a temperature selected between the lower temperature of the melting temperature range of the polymer composition before the heat treatment and the lowest of the polymorph melting peaks narrows the melting temperature range of the polymer composition. To the extent the heating is provided for a sufficient time it will decrease the melting temperature range of the polymer composition. This results in polymer powder that can be used in the SLS process and that avoids the problems associated with SLS of recycled PEKK.

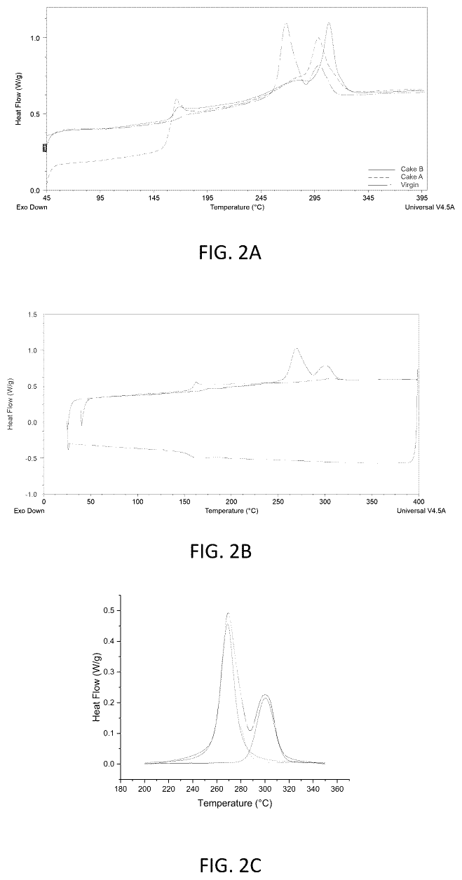

In reference to FIG. 2A, three DSC curves are shown. Differential Scanning Calorimetry or DSC is an accepted method of determining the degree of crystallinity of thermoplastic polymers. The heat of fusion determined from melting semi-crystalline polymers is calculated using standard techniques. The percent crystallinity is reported as a total of the heat flow necessary to melt the polymer. FIG. 2A shows three curves. The first curve is for a powder composition suitable for selective laser sintering comprising virgin PEKK powder. The curve for the virgin PEKK powder is shown isolated in FIG. 2B. The curve includes a first small peak at around 170 degrees Celsius, which is indicative of the glass transition temperature of the virgin PEKK. The curve includes two additional peaks between 250 degrees Celsius and 300 degrees Celsius, which are indicative of the melting peaks of the different polymorphs of the PEKK material.

In reference to FIG. 2C, the melting curve of FIG. 2B for the virgin powder has been deconvoluted using curve fitting functions. As illustrated in FIG. 2C, the over lapping peaks of the different polymorphs of the PEKK are shown. Using this deconvoluting analysis technique, it is possible to determine the melting temperature range of the polymer. The melting temperature range is a range of temperatures from a lower temperature at which the sample begins to liquify to an upper temperature at which the entire sample is liquid. In reference to the virgin PEKK sample shown in FIG. 2C, the sample has a melt temperature range between a lower temperature of 210 degrees Celsius and an upper temperature of 320 degrees Celsius. The temperature range has a delta of 110 degrees Celsius.

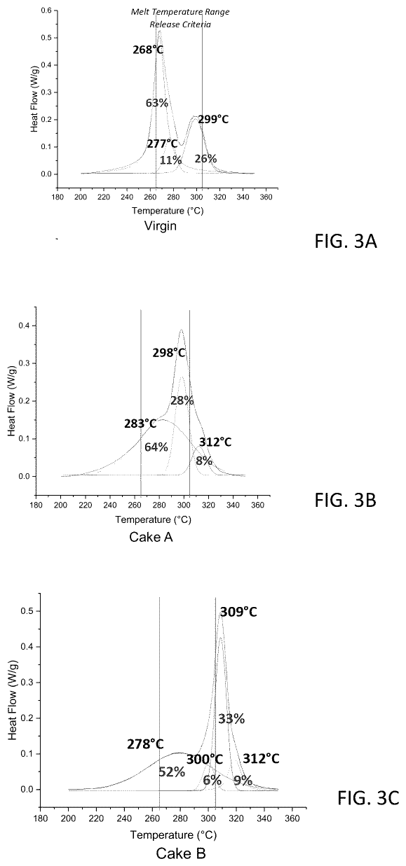

The deconvolution technique and data is also used to determine the relative concentrations of each crystalline form or polymorph and the melting peak of each polymorph. In reference to FIG. 3A, the virgin PEKK powder has three polymorphs. The powder includes a first polymorph represented by the peak on the left. The first polymorph has a melting peak of 268 degrees Celsius and constitutes 63% of the polymer composition. The second polymorph is represented by the smallest peak in the center of the graph. The second polymorph has a melting peak of 277 degrees Celsius and constitutes 11% of the polymer composition. The third polymorph is represented by the peak on the right side of curve shown in FIG. 3A. The third polymorph has a melting peak of 299 degrees Celsius and constitutes 16% of the polymer composition. FIG. 3A further includes a curve that represents the combination of the three polymorphs.

As discussed, deconvoluting the melting enthalpy determined via the DSC determines the specific thermal history of the sample and enables the determinant of further optimum processing parameters. The deconvolution may be performed by known methods. For example, Gaussian, Cauchy-Lorentz, and Voigt functions may be used to deconvolute the calorimetry results. A person of skill in the art and familiar with the disclosure will understand that the present invention is not limited in this regard and that other functions or methods may be applied. The resultant probability distributions are used to analyze spectroscopy results. The identified functions are mathematically defined, and the solutions are iteratively derived. The measured melting enthalpy for the PEKK is a convolution of the contribution from discreet crystalline polymorphs. The individual polymorphs may be identified by the temperature of the center and integrated area of their respective peak. This is referred to as the melting peak of a particular polymorph. The temperatures of the peaks exhibit consistency and regularity, and the areas reveal the relative composition of the material. The deconvolution also identifies the melting range for each crystalline polymorph and the melting range for the powder composition.

In each SLS build, the polymer powder is subject to a bed temperature in the build chamber that is between the lowest of the polymorph melting peaks and the highest of the polymorph melting peaks determined prior to the first selective laser sintering building process. This temperature exposure causes significant material change to the PEKK composition. As the polymer is annealed with every thermal event during the SLS process, the crystalline forms change in relative percentage, and the corresponding optimum melting temperature also changes. As the powder is recycled, the crystalline forms transform to the most ordered structure, as evidenced by the progressively larger peak at a higher temperature. This is illustrated in FIG. 3A-3C, which show deconvolution data for three PEKK powders. FIG. 3A is polymorphs from a powder composition of virgin PEKK powder. FIG. 3B is the polymorphs from a Cake A PEKK powder composition after it has been subjected to a heating load in a first selective laser sintering build process having a bed temperature between the lowest of the polymorph melting peaks and the highest of the polymorph melting peaks determined prior to the first selective laser sintering building process. In this case, the bed temperature was between 268 and 299 degrees Celsius. FIG. 3C is the polymorphs from a Cake B PEKK powder composition after it has been subjected to a heating load in a first selective laser sintering build process and a second selective laser sintering process having a bed temperature between the lowest of the polymorph melting peaks and the highest of the polymorph melting peaks as determined after the first selective laser sintering building process and prior to the second selective laser sintering building process. In this case, the bed temperature was between 283 and 312 degrees Celsius.

As discussed above, the deconvoluted overlapping peaks of the melting phenomenon reveals discreet melting of individual crystalline structural forms, and the change in these forms as a result of subsequent thermal processing.

FIGS. 3A-3C also shown vertical lines on each graph representing the lower melting temperature and the upper melting temperature of a target melt temperature range release criteria. As is evident from the data illustrated in the FIGS., the melt temperature range widens with each successive SLS printing cycle, wherein the powder is subject to a heating load in a selective laser sintering build process having a bed temperature between the lowest of the polymorph melting peaks and the highest of the polymorph melting peaks determined prior to the selective laser sintering building process for the duration of the build process, which may range from twenty four hours to ninety six hours or more.

Table 1, shown below, identifies the melting temperature range for each of the powder compositions illustrated in the charts in FIGS. 3A-3C. This includes data relating to the melting temperature range, including the lower temperature, the upper temperature, and the delta or the difference between the lower temperature and the upper temperature. The table further identifies the melting peak (MP) for each crystalline form of the powder composition and the percentage thereof relative to the powder as a whole.

TABLE 1
Untreated Powder

| | Melting Temperature | | | Polymorph | | Polymorph | | Polymorph | | Polymorph | |
|---|---|---|---|---|---|---|---|---|---|---|---|
| Powder | Range | | | 1 | | 2 | | 3 | | 4 | |
| Type | Lower° C. | Upper° C. | Δ° C. | MP° C. | % | MP° C. | % | MP° C. | % | MP° C. | % |
| Virgin | 210 | 320 | 110 | 268 | 63 | 277 | 11 | 299 | 16 | n/a | n/a |
| Cake A | 210 | 350 | 140 | 283 | 64 | 298 | 28 | 312 | 8 | n/a | n/a |
| Cake B | 200 | 350 | 150 | 278 | 52 | 300 | 6 | 309 | 33 | 312 | 9 |

As the polymer is annealed with every thermal event above the glass-transition temperature, the crystalline forms change in relative percentage, and the corresponding optimum melting temperature also changes. This is illustrated, for example, in Table 1. As the powder is recycled, the crystalline forms transform to the most ordered structure, as evidenced by the progressively larger peak at a higher temperature, for example as shown in FIG. 3C relative to FIGS. 3B and 3A, and as illustrated in the data in Table 1 showing the increase in the percentage of polymorph 3 with each successive build.

The inventors have discovered that with each heat treatment above the melting peak of the lowest polymorph the structure of the polymer composition is altered so that the melting temperature range is increased or widened. In addition, the distribution of the polymorphs becomes skewed to the left. In reference to Table 1, the delta for the melting temperature range of the virgin powder is 110 degrees Celsius, the delta of the Cake A is 140 degrees Celsius, and the delta of the Cake B is 150 degrees Celsius. The change in the melting temperature range is further evident in the expanding base of the melt curves shown in FIGS. 3A-3C, wherein the lower temperature of the melting temperature range is where the curve first materially lifts from the x-axis and the upper temperature is where the curve returns to the x-axis. Also, as shown in FIGS. 3A-3C, the distribution of the polymorphs of the virgin is skewed to the right whereas each successive heat treatment shifts the polymorph distribution further to the left.

The inventors have discovered that the increase in the melting temperature range of the polymer powder and the shift in skewness makes it more difficult to handle and control in the SLS building chamber. The wider melt range manifests itself in powder application issues, and powder sintering issues leading to potentially reduced strength, and to variations in the dimensions of built articles, leading to the tiger striping.

The inventors have discovered a technique for reducing the melting temperature range and reducing the skewness for PEKK powder compositions so as to avoid these disadvantages. Namely, the inventors have discovered that by heat treating the powder for a period of time it is possible to reduce the melting temperature range of the powder composition and narrowing the distribution. In one embodiment of the present invention, powder is heat treated to a temperature between 250 degrees Celsius and the lowest of the polymorph melting peaks for a period of time to reduce the melting temperature range of the powder composition.

The temperature to heat treat the powder may be selected by using the deconvolution data. In one embodiment of the present invention, the temperature is between the lower temperature of the melting temperature range of the polymer composition before the step of subjecting the polymer composition to the heat treatment and the lowest of the polymorph melting peaks. Even more preferably, the temperature to heat treat the polymer composition is between 20 degrees Celsius below the lowest of the polymorph melting peaks and the lowest of the polymorph melting peaks. In some embodiments, the temperature to heat treat the polymer composition is between 10 degrees Celsius below the lowest of the polymorph melting peaks and the lowest of the polymorph melting peaks.

In one embodiment of the present invention, the heat treatment temperature is determined in reference to the melt enthalpy of the powder composition. In one embodiment, the heat treatment temperature was determined to be between 25% and 35% of the lowest polymorph. That is the temperature point where between 25% and 35% of the lowest polymorph had melted. In another embodiment of the present invention, the heat treatment temperature was determined to be 30% of the lowest melting temperature polymorph. In one embodiment, the heat treatment temperature was determined to be between 10% and 20% of the total composition. That is the temperature point where between 10% and 20% of the powder composition has melted. In another embodiment of the present invention, the heat treatment temperature was determined to be 20% of the total powder composition. In some embodiments of the present invention, these numbers are determined on the powder prior to the heat treatment process.

The inventors have discovered that in some embodiments of the present invention and powder compositions used therewith, the temperature to heat treat the polymer composition should be below the lowest of the polymorph melting peaks. This is important to achieve the narrowing of the polymer melting temperature range. To the extent the heat treatment temperature is above the melting peak of the first polymorph, the heat treatment will be similar to the bed temperature conditions during the SLS building wherein the bed temperature is between the melting peak of the lowest polymorph and the highest polymorph, thereby aging the powder further.

After the temperature is selected, the PEKK powder composition is subjected to the temperature of a period of time that decreases the melting temperature range of the polymer composition. The powder may be treated, for example, in a convection oven under ambient conditions. A person of ordinary skill in the art and familiar with the disclosure will understand that different modes and methods of heat treatment may be used in accordance with the present invention. In one embodiment of the present invention, the period of time was experimentally determined as the time necessary to transform all of the lower melting crystalline polymorph to a higher melting form without further transforming the higher melting form(s).

The period of time to heat the powder composition at the determined temperature should be sufficient to reduce the melting temperature range of the powder composition. In one embodiment, the period of time is such that the melting temperature range of the polymer composition is decreased by at least 20%. In another embodiment of the present invention, the composition is treated for a period of time so that the resultant composition has a melting temperature range of 100 degrees Celsius or less. In yet another embodiment, the composition is treated for a period of time so that the resultant composition has a melting temperature range of 60 degrees Celsius or less. In one embodiment of the present invention, a heat treatment duration of between 60 and 80 hours was selected because it fully transformed the polymorphs as desired. In yet another embodiment, the time was selected to be 72 hours. The dwell time should be kept to a minimum and appropriate for a production schedule while achieving the desired polymorphic transformation. In one embodiment of the present invention, including with the data presented herein, air-circulating, convection ovens were used to thermally treat the powders. Although a specific heat treatment method is disclosed, the present invention is not limited in this regard.

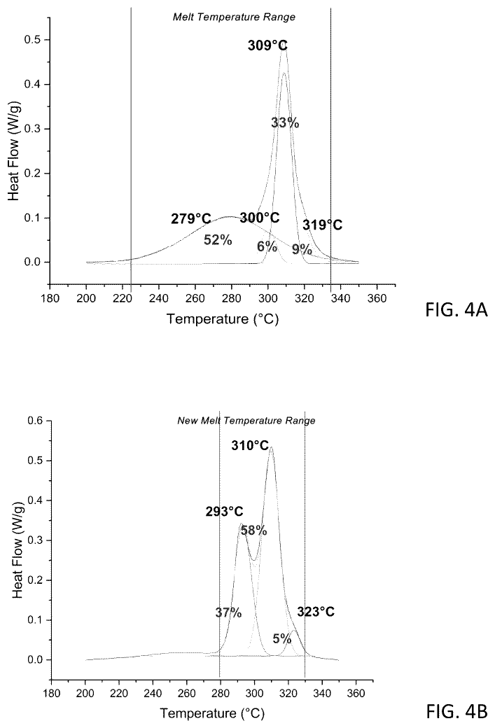

In reference to FIGS. 4A and 4B, the melt data for a Cake B PEKK powder is shown. In FIG. 4A, the Cake B powder illustrated in FIG. 3C is shown. This is PEKK powder that has previously been subjected to a heating load in a first selective laser sintering build process and a second selective laser sintering build process having a bed temperature between the lowest of the polymorph melting peaks and the highest of the polymorph melting peaks as determined immediately prior to the respective selective laser sintering building process.

The Cake B PEKK powder polymer composition was heated at 268 degrees Celsius for seventy two hours. The powder was then analyzed and the results are shown in FIG. 4B. The comparison of the results is shown in Table 2, below. As is evident from the table, the heating treatment had the remarkable effect of sweeping the melting temperature range of the Cake B PEKK powder from a delta of 150 degrees Celsius before the heat treatment to a delta of 57 degrees Celsius after the heat treatment.

TABLE 2
Cake B Power (No Treatment, 268° C. for 72 hours, 275° C. for 72 hours)

| | Melting Temperature | | | Polymorph | | Polymorph | | Polymorph | | Polymorph | | Diff in |
|---|---|---|---|---|---|---|---|---|---|---|---|---|
| | Range | | | 1 | | 2 | | 3 | | 4 | | poly |
| Treat | Lower° C. | Upper° C. | Δ° C. | MP° C. | % | MP° C. | % | MP° C. | % | MP° C. | % | Δ° C. |
| None | 200 | 350 | 150 | 278 | 52 | 300 | 6 | 309 | 33 | 312 | 9 | 34 |
| 268° C. | 278 | 335 | 57 | 293 | 37 | n/a | n/a | 310 | 58 | 323 | 5 | 30 |
| 275° C. | 285 | 350 | 65 | 298 | 21 | n/a | n/a | 310 | 54 | 323 | 25 | 25 |

The effects of the heat treatment at 268 degrees for 72 hours on the Cake B PEKK is also evident in the charts shown in FIGS. 4A and 4B. The charts include vertical bars superimposed on the lower temperature and upper temperature of each melting temperature range before and after the heat treatment. This illustrates the critical reduction in melting temperature range.

The heat treatment also had the effect of shifting the polymorphs to the higher form. The Cake B exhibits four polymorphs. They are identified in Table 2. Polymorph 2 is minimized after the heat treatment. The melting peak of polymorph 1 is increased from 278 to 293 degrees Celsius. The other melting peaks are also increased. The heating increases the content of the higher crystalline forms.

To determine the effectiveness of the treated Cake B powder with the reduced melting temperature range, test parts were manufactured via SLS from the untreated Cake B PEKK powder (Table 3) and the treated Cake B PEKK powder (Table 4). Test specimens were printed in the out-of-plane direction using the prepared powders via an SLS machine and tested in accordance with ASTM D638 and the parts were observed for surface defects. The results of those tests are illustrated below. The build parameters were determined based on standard procedures known in the art using the powder properties. The process chamber temperature was 288 degrees Celsius for the untreated and 290 degrees Celsius for the treated. The build platform temperature and frame temperature were 265 degrees Celsius in both cases. The laser power was 6.5 W for the untreated and 9 W for the treated, determined using known methods. Each build used a scan speed of 2800 mm/s, pre and post-contour of 5 W×1000 mm/s and scan spacing of 0.18 mm.

TABLE 3
Z-Direction Tensile - Control Powder

| | Modulus | Strength | Strain | |
|---|---|---|---|---|
| ID | (ksi) | (ksi) | (%) | Surface Defect |
| 1 | 850 | 8.282 | 1.23 | Tiger Striping |
| 2 | 870 | 9.476 | 1.41 | Tiger Striping |
| 3 | 883 | 12.417 | 1.86 | Tiger Striping |
| 4 | 881 | 11.555 | 1.70 | Light Tiger Striping |
| 5 | 878 | 12.797 | 1.99 | Banding, Light Tiger Striping |
| 6 | 894 | 12.851 | 1.95 | Tiger Striping |
| 7 | 898 | 9.201 | 1.25 | Tiger Striping, Light Spot |
| 8 | 863 | 9.041 | 1.27 | Tiger Striping |
| Mean | 877 | 10.702 | 1.58 | n/a |
| STD | 15.75 | 1.892 | 0.33 | n/a |

TABLE 4
Z-Direction Tensile - Treated Powder

| | Modulus | Strength | Strain | |
|---|---|---|---|---|
| ID | (ksi) | (ksi) | (%) | Surface Defect |
| 1 | 869 | 13.033 | 1.92 | Light Spot |
| 2 | 864 | 14.139 | 2.22 | None |
| 3 | 871 | 13.457 | 2.04 | None |
| 4 | 878 | 13.157 | 1.93 | None |
| 5 | 886 | 14.076 | 2.14 | Light Spot |
| Mean | 873 | 13.572 | 2.05 | n/a |
| STD | 8.43 | 0.513 | 0.13 | n/a |

The treated powder showed a greater than 25% increase in tensile strength as compared to the untreated powder. This was notable because it parts built from Cake B were potentially weaker due to processing difficulties, especially in the out-of-plane direction.

Another unexpected result was that the parts made from the treated powder having the decreased melting temperature range relative to the untreated powder did not exhibit the tiger striping. As shown in the test data, there was no tiger striping observed in the parts manufactured from the treated powder.

Another benefit of the treated powder is that it significantly reduced the hardness of the reclaimed powder. That is powder in the cake bed that is in between the manufactured parts that are sintered by the laser during the SLS. The inventors discovered that the treated powder made it much easier to remove the built parts from the cake bed and it quickened the process. This also reduced the need for bead blasting and increased the amount of powder that was available to be reclaimed. Further, this effect reduced the potential for ergonomic injury and risk of damage to parts. In addition, increased ease of removal of parts had the added benefit of permitting enhanced design complexity of parts made via the SLS.

The Cake B powder was also tested at a heat treatment at 272 degrees Celsius for a period of seventy two hours. The results of the powder are included in Table 2 above. While this temperature was below the first melting peak, its use in SLS resulted in a harder cake bed and it was difficult to remove the powders.

The tempering method is also applicable to virgin PEKK powder and may be used to reduce the melting temperature range of such polymers prior to selective laser sintering and provide additional benefits including reduction in tiger striping and ease of part removal.

In another embodiment of the present invention, the analysis of the melting temperature range and the manipulation thereof via the heat treatment allows for a standardization of recycled powders. In this manner, it is possible to develop a powder profile based using melt temperature range and polymorph melting peaks. Using this profile, it is possible to heat treat different lots of recycled powder so that they are shifted to the proposed profile. In this manner, different lots of recycled powder may be combined for use in selective laser sintering.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

What is claimed is:

1. A method of preparing a polymer powder composition suitable for selective laser sintering, comprising the steps of:
providing a polymer composition comprising at least two polyetherketoneketone polymorphs, each of the polymorphs having a different melting peak, the polymer composition having a melting temperature range between a lower temperature and an upper temperature, each of the melting peaks of the polymorphs falling within the melting temperature range;
determining a temperature to heat treat the polymer composition, the temperature being between 250 degrees Celsius and the lowest of the polymorph melting peaks;
subjecting the polymer composition comprising at least two semicrystalline polymorphs to said temperature being between 250 degrees Celsius and the lowest of the polymorph melting peaks for a period of time that decreases the melting temperature range of the polymer composition.

2. The method of preparing the polymer powder composition of claim 1, wherein the temperature to heat treat the polymer composition is between the lower temperature of the melting temperature range of the polymer composition and the lowest of the polymorph melting peaks.

3. The method of preparing the polymer powder composition of claim 1, wherein the temperature to heat treat the polymer composition is between 20 degrees Celsius below the lowest of the polymorph melting peaks and the lowest of the polymorph melting peaks.

4. The method of preparing the polymer powder composition of claim 3, wherein the temperature to heat treat the polymer composition is between 10 degrees Celsius below the lowest of the polymorph melting peaks and the lowest of the polymorph melting peaks.

5. The method of preparing the polymer powder composition of claim 2, wherein the melting temperature range of the polymer composition is decreased by at least 20%.

6. The method of preparing the polymer powder composition of claim 2, wherein the melting temperature range of the polymer composition is decreased so that it is 100 degrees Celsius or less.

7. The method of preparing the polymer powder composition of claim 6, wherein the melting temperature range of the polymer composition is decreased so that it is 60 degrees Celsius or less

8. The method of preparing the polymer powder composition of claim 6, wherein the polymer composition has previously been subjected to a heating load in a first selective laser sintering build process having a bed temperature between the lowest of the polymorph melting peaks and the highest of the polymorph melting peaks determined prior to the first selective laser sintering building process.

9. The method of preparing the polymer powder composition of claim 8, wherein the polymer composition has previously been subjected to a heating load in a second selective laser sintering build process having a bed temperature between the lowest of the polymorph melting peaks and the highest of the polymorph melting peaks as determined after the first selective laser sintering building process and prior to the second selective laser sintering building process.

10. The method of preparing the polymer powder composition of claim 9, wherein the polyetherketoneketone comprises repeating units represented by Formulas I and II:
-A-C(═O)—B—C(═O)— I (Isomer T)
-A-C(═O)-D-C(═O)— II (Isomer I)
where A is a p,p′-Ph-O-Ph- group, Ph is a phenylene radical, B is p-phenylene, and D is m-phenylene, wherein the T:I isomer ratio is in the range of from 50/50 to 90/10, thereby forming said heat-treated polymer composition.

11. The method of preparing the polymer powder composition of claim 10, wherein the T:I ratio is 60:40

12. The polymer powder composition of claim 9, wherein the step of determining the temperature to heat treat the polymer composition comprises the step of deconvoluting an endothermic melting peak of the polymer composition to determine the melting temperature range of the polymer composition and to determine the melting peak of each of the polymorphs.

13. A polymer powder composition suitable for selective laser sintering, comprising:
a polymer composition comprising at least two polyetherketoneketone polymorphs, each of the polymorphs having a different melting peak, the polymer composition having a melting temperature range between a lower temperature and an upper temperature, each of the melting peaks of the polymorphs falling within the melting temperature range, the polymer powder composition made by a process comprising the following steps:
determining a temperature to heat treat the polymer composition, the temperature being between 250 degrees Celsius and the lowest of the polymorph melting peaks;
subjecting the polymer composition comprising at least two semicrystalline polymorphs to said determined temperature being between 250 degrees Celsius and the lowest of the polymorph melting peaks for a period of time that decreases the melting temperature range of the polymer composition.

14. The polymer powder composition of claim 13, wherein the temperature to heat treat the polymer composition is between the lower temperature of the melting temperature range of the polymer composition before the step of subjecting the polymer composition to the temperature for the period of time and the lowest of the polymorph melting peaks.

15. The polymer powder composition of claim 13, wherein the temperature to heat treat the polymer composition is between 10 Celsius below the lowest of the polymorph melting peaks and the lowest of the polymorph melting peaks.

16. The polymer powder composition of claim 15, wherein the temperature to heat treat the polymer composition is between 10 Celsius below the lowest of the polymorph melting peaks and the lowest of the polymorph melting peaks.

17. The polymer powder composition of claim 14, wherein the melting temperature range of the polymer composition is decreased by at least 20%.

18. The polymer powder composition of claim 14, wherein the melting temperature range of the polymer composition is decreased so that it is 100 degrees Celsius or less

19. The polymer powder composition of claim 18, wherein the melting temperature range of the polymer composition is decreased so that it is 60 degrees Celsius or less

20. The polymer powder composition of claim 18, wherein the polymer composition has previously been subjected to a heating load in a first selective laser sintering build process having a bed temperature between the lowest of the polymorph melting peaks and the highest of the polymorph melting peaks determined prior to the first selective laser sintering building process.

21. The polymer powder composition of claim 20, wherein the polymer composition has previously been subjected to a heating load in a second selective laser sintering build process having a bed temperature between the lowest of the polymorph melting peaks and the highest of the polymorph melting peaks as determined after the first selective laser sintering building process and prior to the second selective laser sintering building process.

22. The polymer powder composition of claim 21, wherein the polyetherketoneketone comprises repeating units represented by Formulas I and II:
-A-C(═O)—B—C(═O)— I (Isomer T)
-A-C(═O)-D-C(═O)— II (Isomer I)
where A is a p,p′-Ph-O-Ph- group, Ph is a phenylene radical, B is p-phenylene, and D is m-phenylene, wherein the T:I isomer ratio is in the range of from 50/50 to 90/10, thereby forming said heat-treated polymer composition.

23. The polymer powder composition of claim 22, wherein the T:I ratio is 60:40

24. The polymer powder composition of claim 21, wherein the step of determining the temperature to heat treat the polymer composition comprises the step of deconvoluting an endothermic melting peak of the polymer composition to determine the melting temperature range of the polymer composition and to determine the melting peak of each of the polymorphs.
